(19) United States
(12) Patent Application Publication
(10) Pub. No.: US 2015/0189536 A1
(43) Pub. Date: Jul. 2, 2015

(54) METHOD AND APPARATUS FOR AGILE WIRELESS NETWORK SIGNAL ADAPTATION

(71) Applicant: CAMBRIDGE SILICON RADIO LIMITED, Cambridge (GB)

(72) Inventor: Swaroop VENKATESH, Pleasanton, CA (US)

(21) Appl. No.: 14/145,154

(22) Filed: Dec. 31, 2013

(51) Int. Cl. H04W 28/02; H04L 5/00

(52) U.S. Cl. CPC H04W 28/0236; H04W 28/0252; H04L 5/0062; H04W 84/12

(57) ABSTRACT

According to certain general aspects, the present invention provides a wireless networking scheme that adaptively modifies the transmitted signal bandwidth to avoid interference from or to other devices or systems (e.g., 802.11p) and to meet regulatory requirements (e.g., DFS). In embodiments, if a transmitter according to the invention is operating in a channel with high bandwidth, and if interference is detected or needs to be avoided on a non-primary portion of the occupied bandwidth, the transmitter adaptively reduces the portion of the bandwidth used for transmission to minimize interference. This allows the transmitter to reduce interference or meet compliance requirements without significantly compromising throughput.

### FIELD OF THE INVENTION

The present invention relates generally to wireless networking, and more particularly to a wireless networking scheme that adaptively modifies the transmitted signal bandwidth to avoid interference from or to other devices or systems and/or to meet regulatory requirements.

### BACKGROUND OF THE INVENTION

As wireless networking (i.e. WiFi or WLAN) has become increasingly ubiquitous, demands for bandwidth have also greatly increased. Accordingly, wireless standards defined by IEEE 802.11 have provided ever-increasing capacities, from 20 MHz defined by legacy IEEE 802.11 a/g to 160 MHz defined by the newer IEEE. 802.11 ac standard.

Meanwhile, in the 5 GHz wireless band, there are some sub-bands where the detection of weather and military radars is mandated by the regulatory bodies (e.g. FCC, ETSI, etc.). This is known as Dynamic Frequency Selection (DFS). If a radar signal is detected in the sub-band in which a wireless device is operating, the device is required to stop transmission in that sub-band. In addition, the compliance rules require a non-occupancy period typically around 30 minutes.

Typically, avoiding interference with radar and other transmissions in compliance with FCC and other regulations requires changing to another sub-band (i.e. channel). Switching to another channel (assuming one is available) requires time and handshaking between transceivers, resulting in interruption in service. For wireless applications involving audio or video distribution, these interruptions adversely impact end-user experience. Furthermore, for 80 MHz and 160 MHz devices especially, if radar is detected, there are very few alternative channels to occupy. As shown in FIG. 1, the number of available channels goes down as the device bandwidth increases. More particularly, in the 5 GHz band, the number of 20 MHz channels 102 is 25. This reduces to twelve 40 MHz channels, five 80 MHz channels, and only two 160 MHz channels 104.

Relatedly, there some sub-bands relatively close to the 5 GHz wireless bands for which interference caused by device transmissions should be avoided. For example, as shown in FIG. 2, the ITS band 202 from 5855 MHz to 5925 MHz is used for 802.11p vehicular communication, which is separated by the highest 802.11 sub-bands 204 by only 20 MHz. There are concerns of interference from 802.11 networks to the nearby vehicular safety channels.

Accordingly, there exists a need for a device and method that adaptively enables wireless network operation at as high a bandwidth as possible without interfering with regulations or other systems.

### SUMMARY OF THE INVENTION

According to certain general aspects, the present invention provides a wireless networking scheme that adaptively modifies the transmitted signal bandwidth to avoid interference from or to other devices or systems (e.g., 802.11p) and to meet regulatory requirements (e.g., DFS). In embodiments, if a transmitter according to the invention is operating in a channel with high bandwidth, and if interference is detected or needs to be avoided on a non-primary portion of the occupied bandwidth, the transmitter adaptively reduces the portion of the bandwidth used for transmission to minimize interference. This allows the transmitter to reduce interference or meet compliance requirements without significantly compromising throughput.

In accordance with these and other aspects, a method according to embodiments of the invention includes selecting a channel for wireless network communications, the channel having a full bandwidth consisting of a sum between a primary portion and a non-primary portion, transmitting signals in the primary portion and the non-primary portion of the channel, detecting interference associated with the non-primary portion of the channel, and in response to the detected interference, transmitting signals only in a reduced portion of the channel, the reduced portion including the primary portion, but having a reduced bandwidth less than the full bandwidth.

### BRIEF DESCRIPTION OF THE DRAWINGS

These and other aspects and features of the present invention will become apparent to those ordinarily skilled in the art upon review of the following description of specific embodiments of the invention in conjunction with the accompanying figures, wherein:

FIG. 1 illustrates how the number of available channels goes down as the device bandwidth increases in conventional wireless networks;

FIG. 2 illustrates how the ITS band used for 802.11p vehicular communication is separated by the highest 802.11 sub-bands;

FIG. 3 illustrates aspects of IEEE 802.11 backward compatibility recognized by the present inventors;

FIG. 4 is a functional block diagram of an example system according to embodiments of the invention;

FIG. 5 is a flowchart illustrating an example methodology according to embodiments of the invention;

FIGS. 6A to 6C illustrate operation of embodiments of the invention in Use Case 1: a wireless device operating in IEEE 802.11ac 160 MHz mode;

FIGS. 7A and 7B illustrate operation of embodiments of the invention in Use Case 2: a wireless device operating in IEEE 802.11ac 80 MHz mode; and

FIGS. 8A and 8B illustrate operation of embodiments of the invention in Use Case 3: a wireless device operating in IEEE 802.11ac 80 MHz mode in the presence of an IEEE 802.11p-based vehicular communication system.

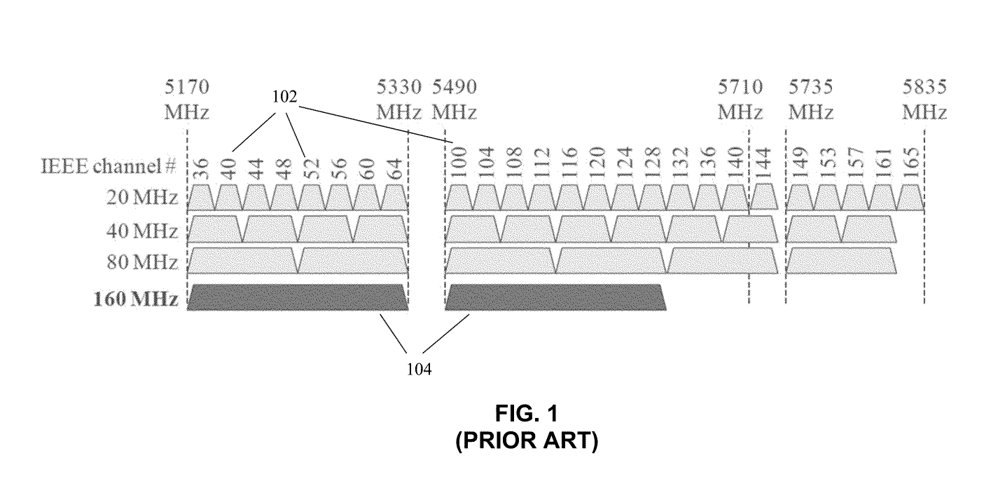

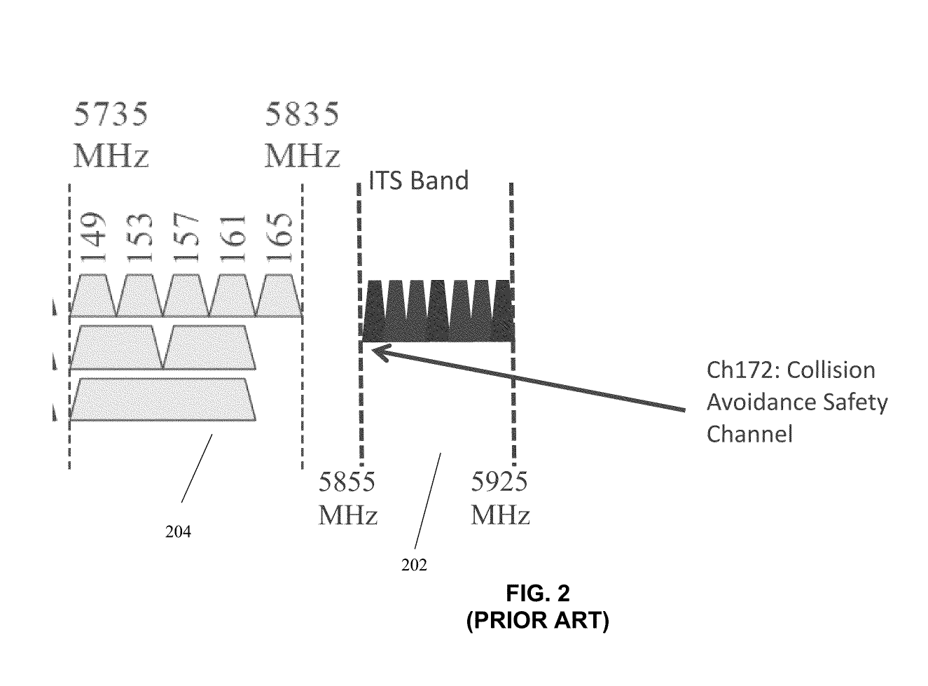

### DETAILED DESCRIPTION OF THE PREFERRED EMBODIMENTS

The present invention will now be described in detail with reference to the drawings, which are provided as illustrative examples of the invention so as to enable those skilled in the art to practice the invention. Notably, the figures and examples below are not meant to limit the scope of the present invention to a single embodiment, but other embodiments are possible by way of interchange of some or all of the described or illustrated elements. Moreover, where certain elements of the present invention can be partially or fully implemented using known components, only those portions of such known components that are necessary for an understanding of the present invention will be described, and detailed descriptions of other portions of such known components will be omitted so as not to obscure the invention. Embodiments described as being implemented in software should not be limited thereto, but can include embodiments implemented in hardware, or combinations of software and hardware, and vice-versa, as will be apparent to those skilled in the art, unless otherwise specified herein. In the present specification, an embodiment showing a singular component should not be considered limiting; rather, the invention is intended to encompass other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

According to certain general aspects, the present invention provides a wireless networking scheme that adaptively modifies the transmitted signal bandwidth to avoid interference from or to other devices or systems (e.g., 802.11p) and to meet regulatory requirements (e.g., DFS). This scheme provides measurable performance improvement at the system-level, is easily detectable at the system-level, and is particularly useful for wireless systems with limited numbers of available channels.

According to some aspects, the present inventors recognize that IEEE 802.11 WLAN systems are backward compatible. This means, for example, that IEEE 802.11n compatible transmitters/receivers capable of operating at 40 MHz bandwidth can also transmit and receive legacy (i.e. IEEE 802.11g or 802.11a) 20 MHz bandwidth packets. Similarly, IEEE 802.11ac compatible transmitters/receivers capable of operating at 80 MHz bandwidth can also transmit and receive 40 MHz IEEE 802.11n packets, 20 MHz IEEE 802.11n packets and 20 MHz IEEE 802.11g/a packets. Further similarly, IEEE 802.11 ac compatible transmitters/receivers capable of operating at 160 MHz bandwidth can also transmit and receive 80 MHz IEEE 802.11ac packets, 40 MHz IEEE 802.11n packets, 20 MHz IEEE 802.11n packets and 20 MHz IEEE 802.11g/a packets.

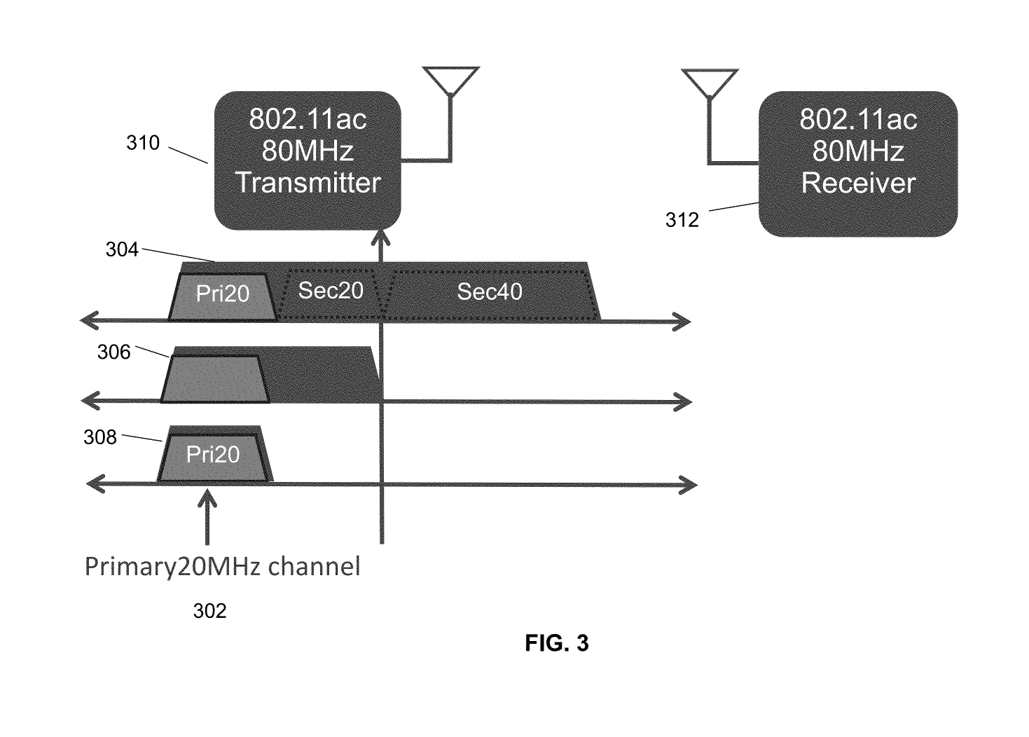

This backward compatibility is further illustrated in FIG. 3. As is known, IEEE 802.11 uses an orthogonal frequency division multiplexing (OFDM) transmission scheme, with carriers throughout the channel used for communications. As long as the transmitted packet uses the carriers spanning the “primary” 20 MHz sub-channel 302, the IEEE 802.11 compatible transmitter 310 can transmit either a packet spanning an 80 MHz secondary sub-channel 304 that overlaps the primary sub-channel 302, or a packet spanning a 40 MHz secondary sub-channel 306 or a packet spanning just the 20 MHz sub-channel 308 and expect the IEEE 802.11 80 MHz capable receiver 312 to receive the packet.

According to aspects of the invention, therefore, if a transmitter is operating in a 40 MHz, 80 MHz, or 160 MHz mode, and interference is detected or needs to be avoided on a non-primary portion of the occupied bandwidth, the transmitter adaptively reduces the portion of the bandwidth used for transmission to minimize interference. This allows the transmitter to reduce interference or meet compliance requirements without significantly compromising throughput.

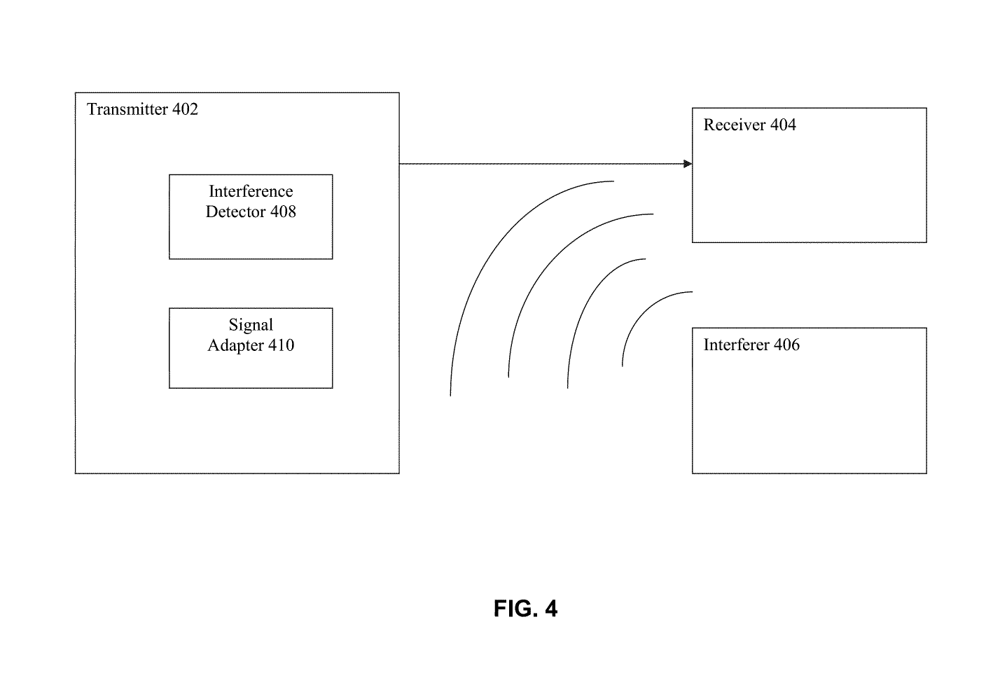

A functional block diagram of an example system according to embodiments of the invention is shown in FIG. 4. As shown in FIG. 4, the system includes a wireless transmitter 402 and a wireless receiver 404. It should be noted that either or both of transmitter 402 and receiver 404 can be included in devices that also have a receiver and transmitter, respectively. In embodiments, transmitter 402 and receiver 404 are capable of operating in accordance with IEEE 802.11n or higher standards such as IEEE 802.11 ac. However, other embodiments of the invention include other wireless systems having the backward compatibility aspects described above.

Interferer 406 is a radar or other RF transmitter or transmission system (e.g. IEEE 802.11p system) in or adjacent to the bandwidth used by transmitter 402 and receiver 404. It should be noted that the term “interferer” is not limited to signals or systems that actively and/or adversely impact the signals used by transmitter 402 and receiver 404. Rather, it includes other signals and systems that should not be impacted by the signals used by transmitter 402 and receiver 404.

Transmitter 402 and receiver 404 can be included in any device that conventionally or in the future includes wireless (e.g. WiFi) functionality. Such devices include, without limitation, modems, access points, desktop or notebook computers (e.g. Windows or Apple compatible), pad or tablet computers (e.g. iPad, etc.), smart phones (e.g. iPhone, Galaxy, etc.), televisions, DVD players, hands-free systems (e.g. for automobiles), etc.

It should be noted that transmitter 402 and receiver 404 include conventional components for transmitting and receiving wireless signals such as antennas, RF front ends, signal processors and the like, as well as for formatting and de-formatting data conveyed by such signals in accordance with standards such as IEEE 802.11. However, further details thereof will be omitted here for sake of clarity of the invention.

According to embodiments of the invention shown in FIG. 4, an example transmitter 402 includes an interference detector 408 and a bandwidth adapter 410. Where transmitter 402 is implemented by one or more integrated circuits (e.g. ASICs, chipsets, etc.), detector 408 and/or adapter 410 can be partially or fully implemented by firmware or software embedded in such integrated circuit(s). Those skilled in the art will understand how to implement the functionality of detector 408 and adapter 410 in these and other embodiments after being taught by the present examples.

It should be noted, however, that certain functionalities of detector 406 and/or adapter 408 can be implemented by techniques that are provided in conventional wireless devices. For example, many conventional wireless devices include some form of interference detection and/or avoidance and/or some form of signal transmission adaptation (e.g. rate adaptation). Those skilled in the art will further understand how to supplement and/or replace such conventional functionalities with the functionalities of the present invention after being taught by the present examples.

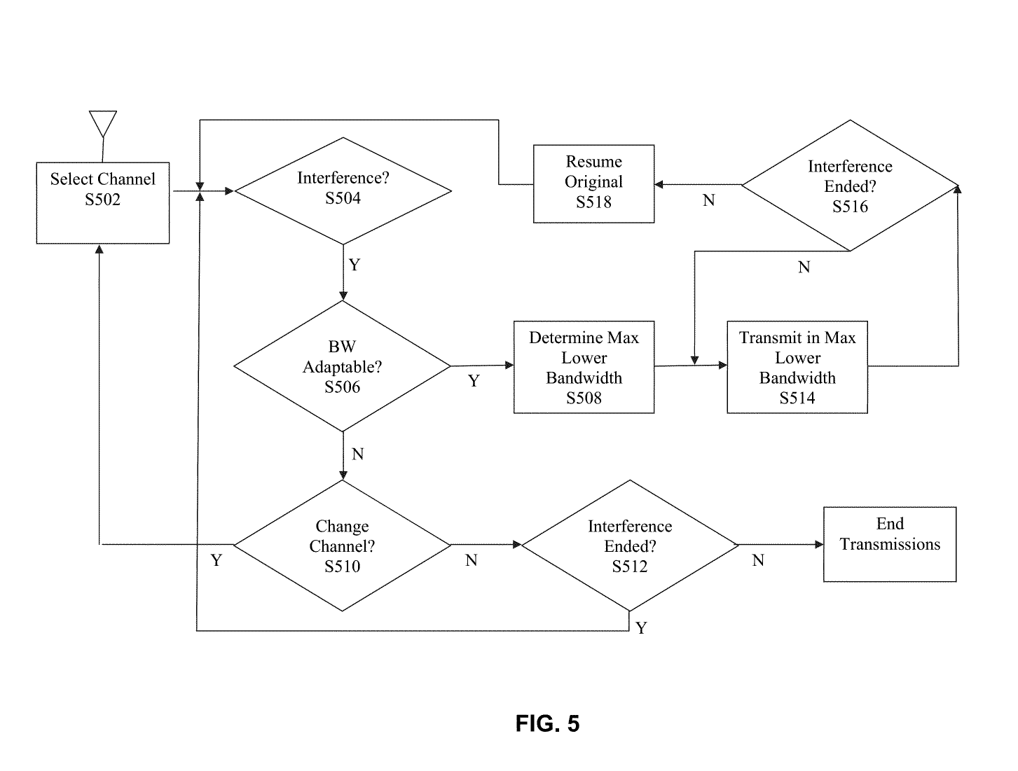

A flowchart illustrating an example methodology according to embodiments of the invention is shown in FIG. 5.

As shown in FIG. 5, in step S502 transmitter 402 selects a high bandwidth channel (e.g. 40 MHz, 80 MHz, 160 MHz) for transmitting data. This can be done in any conventional manner. For example, transmitter 402 can first select a primary 20 MHz channel for initial communications with receiver 404 and incrementally increase to higher bandwidth channels sharing this primary 20 MHz channel until receiver 404 fails to acknowledge receipt of transmitted packets.

Next, in step S504, interference detector 408 in transmitter 402 determines whether interference exists in or near the selected channel and if the interference is found to be present, identify specific sub-channels in which the interference is present. For example, radar signals are typically narrowband and have a relatively high signal strength compared to the average signal strength of the wireless signal across the bandwidth of the selected channel. Accordingly, detector 408 can include a threshold detector and determine when any other signals are being transmitted within in or near the selected channel above the threshold. Many other conventional or proprietary detection techniques are possible, and the invention is not limited to this example. As another example, where transmitter 402 is included in a device that also has a receiver, a receive chain can be dedicated or configured to detect various known and specific signals (e.g. known radar signals, etc.).

If interference has been detected, processing advances to step S506 where bandwidth adapter 410 in transmitter determines whether bandwidth can be adjusted to avoid the detected interference. For example, if the selected channel is an 80 MHz bandwidth channel, and if the detected interference is outside of the 20 MHz primary channel included within the selected 80 MHz channel, then adapter 410 determines that bandwidth adaptation can be used, and processing advances to step S508. Otherwise, processing advances to step S510 where it is determined whether another channel can be selected to avoid the interference in the conventional manner, and if so processing returns to step S502. If no other channel can be used, transmissions end until the interference ends or in accordance with other compliance standards, as determined in step S512.

In step S508, bandwidth adapter 410 determines the maximum bandwidth within the selected channel that can still be used while avoiding the detected interference. For example, if the selected channel is 80 MHz, and when the detected interference is outside the 40 MHz channel within the selected channel that also includes the primary 20 MHz channel, then adapter 410 determines that that 40 MHz channel can be used.

Next, in step S514 transmitter 402 begins transmissions within the selected channel at the lower bandwidth determined in step S508. These lower bandwidth transmissions continue until it is determined in step S516 if the interference has ended and/or if regulatory requirements have been satisfied. In that event, in step S518 bandwidth adapter 410 causes transmitter 402 to change back to the original high bandwidth transmissions in the channel selected in S502.

The following figures illustrate example Use Cases in which embodiments of the invention can be applied.

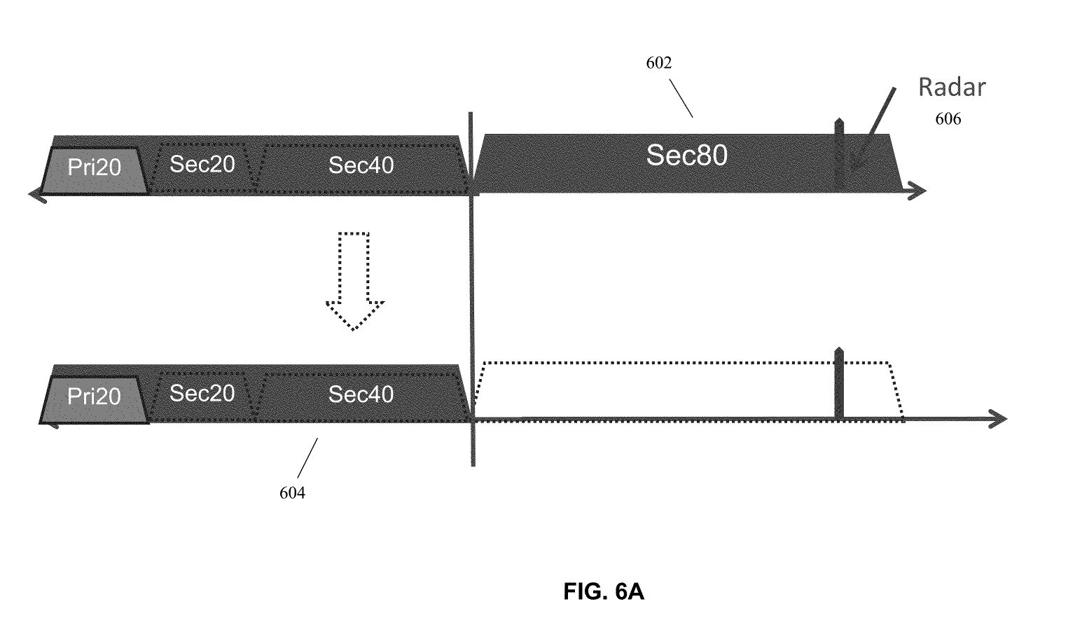

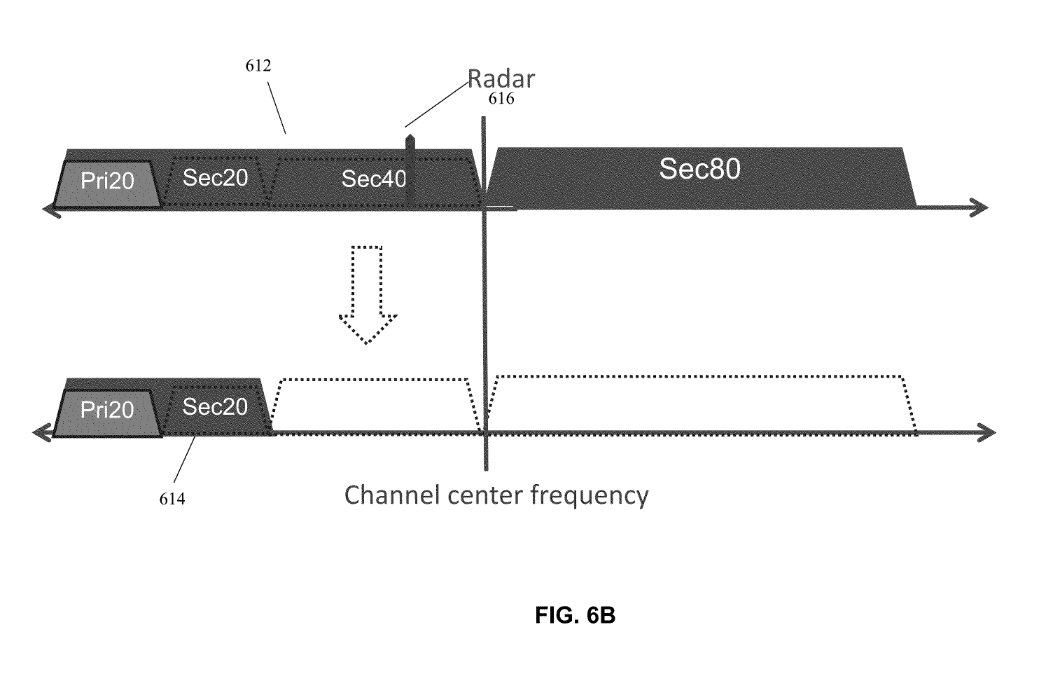

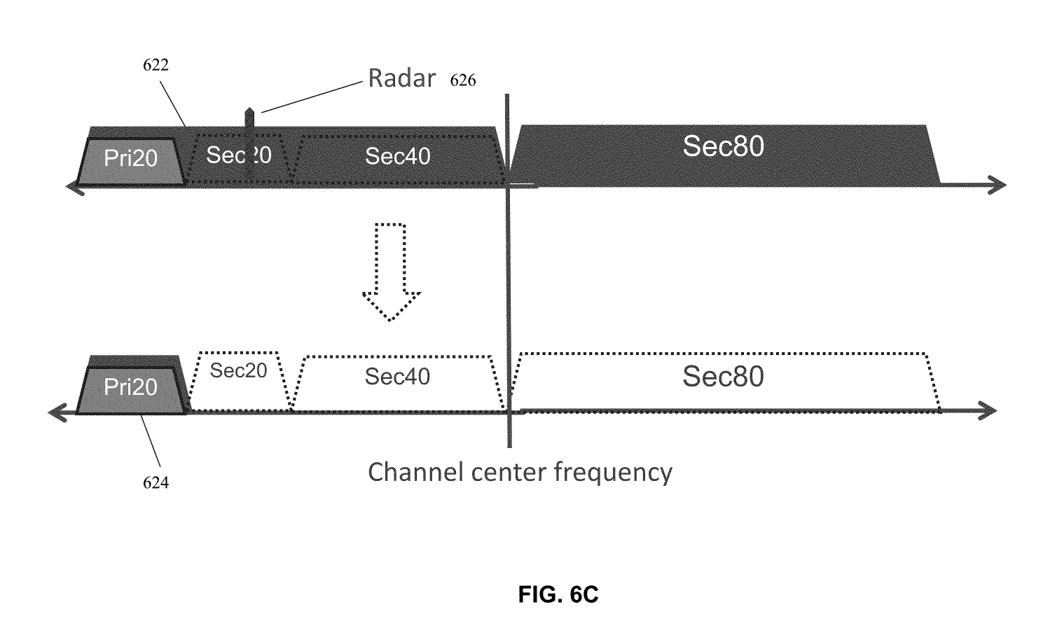

FIGS. 6A to 6C illustrate operation of embodiments of the invention in Use Case 1: a wireless device operating in IEEE 802.11ac 160 MHz mode.

Particularly, FIG. 6A illustrates an example in which radar signal 606 is detected in a non-primary portion 602 of the occupied bandwidth in 160 MHz mode. In this case, the transmitter devolves to a 80-in-160 transmission scheme using 80 MHz packets in the 80 MHz bandwidth primary portion 604 to avoid interfering with the radar installations.

FIG. 6B illustrates an example where radar signal 616 is detected in a non-primary portion 612 of the occupied bandwidth in 160 MHz mode. In this case, the transmitter devolves to a 40-in-160 transmission scheme using 40 MHz packets in the 40 MHz bandwidth primary portion 614 to avoid interfering with the radar installations.

FIG. 6C illustrates an example where radar signal 626 is detected in the secondary 20 MHz channel 622. In this case, the transmitter needs to devolve to a 20 in 160 transmission scheme using 20 MHz packets within primary channel 624.

It should be noted that if radar is detected in the primary 20 MHz channel 624, then there is no recourse, and the transmitter needs to stop transmissions in the channel per DFS compliance rules.

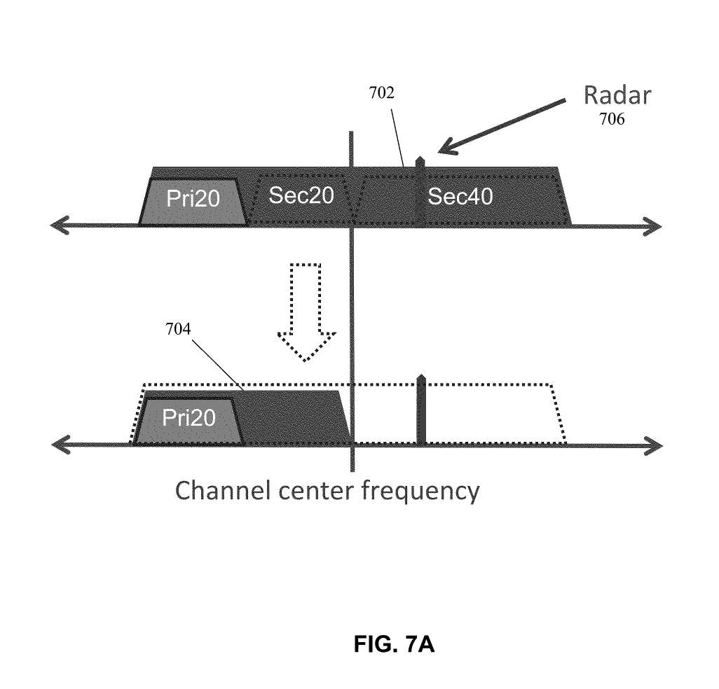

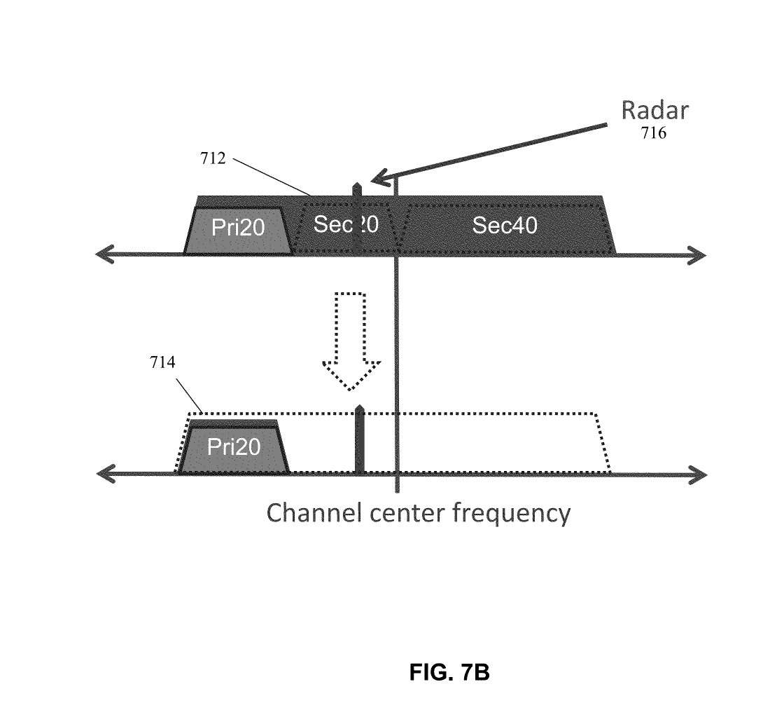

FIGS. 7A and 7B illustrate operation of embodiments of the invention in Use Case 2: a wireless device operating in IEEE 802.11 ac 80 MHz mode.

Particularly, FIG. 7A illustrates an example in which radar signal 706 is detected in a non-primary portion 702 of the occupied bandwidth in 80 MHz mode. In this case, the transmitter devolves to a 40-in-80 transmission scheme using 40 MHz packets in the 40 MHz bandwidth primary portion 804 to avoid interfering with the radar installations.

FIG. 7B illustrates an example where radar signal 716 is detected in the secondary 20 MHz channel 712. In this case, the transmitter needs to devolve to a 20 in 40 transmission scheme using 20 MHz packets within primary channel 714.

It should be noted that if radar is detected in the primary 20 MHz channel 714, then there is no recourse, and the transmitter needs to stop transmissions in the channel per DFS compliance rules.

It should be noted that the schemes described above can be directly extended to 802.11n systems as well, where a 40 MHz device can devolve to 20 MHz transmissions.

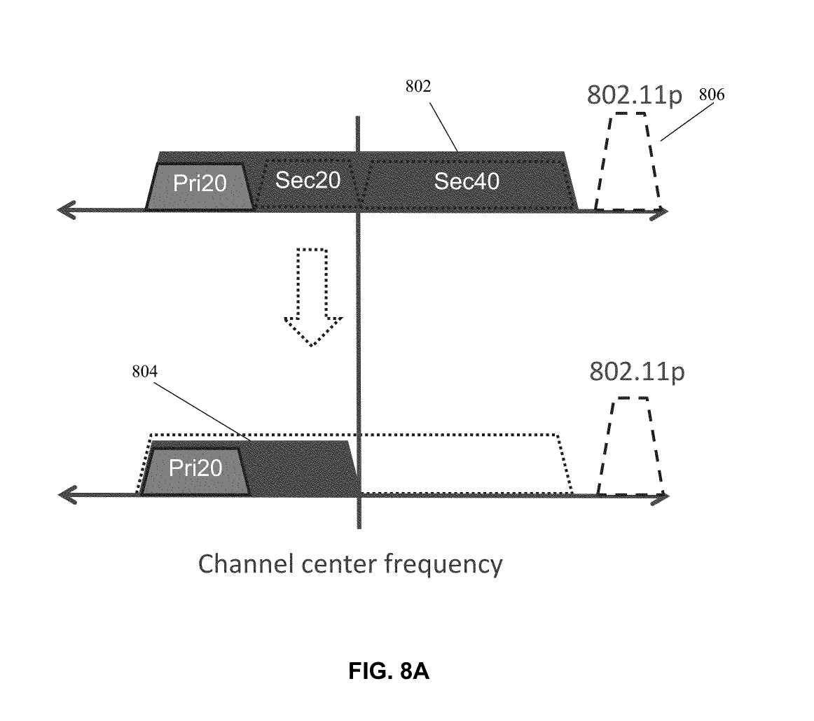

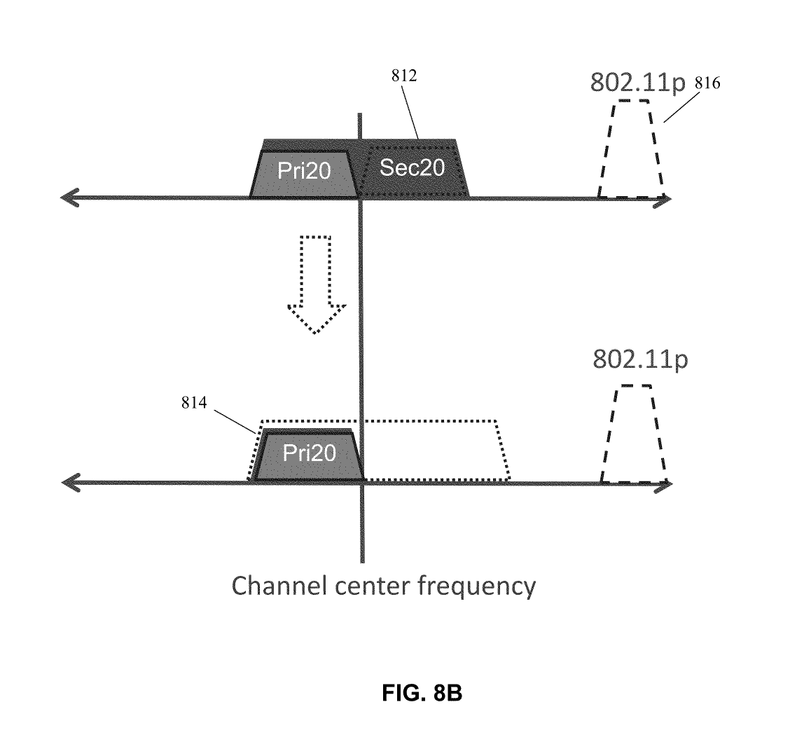

FIGS. 8A and 8B illustrate operation of embodiments of the invention in Use Case 3: a wireless device operating in IEEE 802.11ac 80 MHz mode in the presence of an IEEE 802.11p-based vehicular communication system.

Particularly, FIG. 8A illustrates an example in which IEEE 802.11p system activity 806 is detected adjacent to a non-primary portion 802 of the occupied bandwidth in 80 MHz mode. In this case, the transmitter devolves to a 40-in-80 transmission scheme using 40 MHz packets in the 40 MHz bandwidth primary portion 804 to avoid interfering with the IEEE 802.11p activity.

FIG. 8B illustrates an example where IEEE 802.11p system activity 816 is detected adjacent to the secondary 20 MHz channel 812. In this case, the transmitter needs to devolve to a 20 in 40 transmission scheme using 20 MHz packets within primary channel 814.

It should be noted that if IEEE 802.11p system activity is detected in or adjacent to the primary 20 MHz channel 814, then there is no recourse, and the transmitter needs to stop transmissions in the channel.

It should be noted that this scheme can also be extended to WLAN operating in a 2.4 GHz band, for example to minimize interference to/from Bluetooth devices.

Although the present invention has been particularly described with reference to the preferred embodiments thereof, it should be readily apparent to those of ordinary skill in the art that changes and modifications in the form and details may be made without departing from the spirit and scope of the invention. It is intended that the appended claims encompass such changes and modifications.

What is claimed is:

1. A method implemented by one or more integrated circuits comprising:
selecting a channel for wireless network communications, the channel having a full bandwidth consisting of a sum between a primary portion and a non-primary portion of the channel;
transmitting signals in the primary portion and the non-primary portion of the channel;
detecting interference associated with the non-primary portion of the channel; and
using the one or more integrated circuits, in response to the detected interference, transmitting signals only in a reduced portion of the channel, the reduced portion including the primary portion, but having a reduced bandwidth less than the full bandwidth.

2. A method according to claim 1, wherein the primary portion comprises a primary sub-channel and wherein the non-primary portion comprises one or more secondary sub-channels adjacent to or overlapping the primary sub-channel.

3. A method according to claim 2, wherein the reduced portion consists of one of the secondary sub-channels overlapping the primary sub-channel.

4. A method according to claim 2, wherein the reduced portion consists of only the primary sub-channel.

5. A method according to claim 1, wherein the wireless network communications are compatible with IEEE 802.11.

6. A method according to claim 5, wherein the interference comprises a radar signal having a frequency within the full bandwidth of the channel.

7. A method according to claim 6, further comprising:
continuing transmitting signals in only the reduced portion for a time period in compliance with regulatory agency rules.

8. A method according to claim 5, wherein the interference comprises another wireless network system having operating frequencies near the non-primary portion of the channel.

9. A method according to claim 8, wherein the another wireless network system comprises an IEEE 802.11p compatible system.

10. A method according to claim 2, wherein the wireless network communications are compatible with IEEE 802.11ac, and wherein the channel consists of a 160 MHz channel, and wherein the one or more secondary sub-channels consist of 80 MHz, 40 MHz and 20 MHz sub-channels within the full bandwidth of the 160 MHz channel.

11. A method according to claim 2, wherein the wireless network communications are compatible with IEEE 802.11ac, and wherein the channel consists of a 80 MHz channel, and wherein the one or more secondary sub-channels consist of 40 MHz and 20 MHz sub-channels within the full bandwidth of the 160 MHz channel.

12. An apparatus comprising:
a transmitter that transmits signals in a channel for wireless network communications, the channel having a full bandwidth consisting of a sum between a primary portion and a non-primary portion of the channel;
an interference detector that detects interference associated with the non-primary portion of the channel; and
a signal adapter that, in response to the detected interference, causes the transmitter to transmit signals only in a reduced portion of the channel, the reduced portion including the primary portion, but having a reduced bandwidth less than the full bandwidth.

13. An apparatus according to claim 12, wherein the primary portion comprises a primary sub-channel and wherein the non-primary portion comprises one or more secondary sub-channels adjacent to or overlapping the primary sub-channel.

14. An apparatus according to claim 13, wherein the reduced portion consists of one of the secondary sub-channels overlapping the primary sub-channel.

15. An apparatus according to claim 13, wherein the reduced portion consists of only the primary sub-channel.

16. An apparatus according to claim 12, wherein the wireless network communications are compatible with IEEE 802.11.

17. An apparatus according to claim 13, wherein the wireless network communications are compatible with IEEE 802.11ac, and wherein the channel consists of a 160 MHz channel, and wherein the one or more secondary sub-channels consist of 80 MHz, 40 MHz and 20 MHz sub-channels within the full bandwidth of the 160 MHz channel.

18. An apparatus according to claim 13, wherein the wireless network communications are compatible with IEEE 802.11ac, and wherein the channel consists of a 80 MHz channel, and wherein the one or more secondary sub-channels consist of 40 MHz and 20 MHz sub-channels within the full bandwidth of the 160 MHz channel.
